(19) United States
(12) Patent Application Publication
(10) Pub. No.: US 2009/0140990 A1
(43) Pub. Date: Jun. 4, 2009

(54) TOUCH SCREEN, TOUCH PANEL AND MANUFACTURING METHOD THEREOF

(75) Inventors: Sean Chang, Taoyuan Hsien (TW); Chii-How Chang, Taoyuan Hsien (TW); Yang-Lin Chen, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/053,335

(22) Filed: Mar. 21, 2008

(30) Foreign Application Priority Data
Nov. 30, 2007 (TW) 096145565

(51) Int. Cl. G06F 3/041

(52) U.S. Cl. 345/173

(57) ABSTRACT

A touch panel includes a substrate, a conductive circuit layer, a resistive layer and a dielectric layer. The substrate has a touch area and a peripheral area surrounding the touch area. The conductive circuit layer is formed on the peripheral area of the substrate. The resistive layer covers the conductive circuit layer and the touch area of the substrate. The dielectric layer is formed on the resistive layer. The conductive circuit layer includes a plurality of signal terminals disposed on corner surfaces of the substrate as the corner electrodes of the conductive circuit layer.

### CROSS REFERENCE TO RELATED APPLICATIONS

This Non-provisional application claims priority under 35 U.S.C. §119(a) on Patent Application No(s). 096145565 filed in Taiwan, Republic of China on Nov. 30, 2007, the entire contents of which are hereby incorporated by reference.

### BACKGROUND OF THE INVENTION

1. Field of Invention

The invention relates to a touch screen, a touch panel and a manufacturing method thereof. More particularly, the invention relates to a touch panel and a touch screen having a resistive layer and an anti-reflective layer formed on the resistive layer.

2. Related Art

Recently, the touch panel has been widely applied to many kinds of electronic products, such as the mobile communication device, digital camera, MP3 player, PDA, GPS hand-held PC or ultra mobile PC (UMPC). In the above-mentioned applications, the touch panel is associated with a display screen to form a touch screen. Regarding to the touch screen, the sensitivity and preciseness thereof are very importance factors for the product performance. In addition, the manufacturing processes of the touch panel will affect the production cost thereof.

FIG. 1 shows a conventional touch screen 1, and FIG. 2 is a sectional view showing a part of the touch screen 1. The touch screen includes a touch panel 11 and an external circuit 12. The touch panel 11 includes a substrate 111, a resistive layer 112, a conductive circuit layer 113, a plurality of signal terminals 114 and a protective layer 116. The substrate 111 has a touch area T₁ and a peripheral area P₁ disposed around the touch area T₁. The conductive circuit layer 113 and the signal terminals 114 are formed on a portion of the resistive layer 112 located on the peripheral area P₁. The protective layer 116 covers the conductive circuit layer 113 and the signal terminals 114 for protection. The external circuit 12 is electrically connected to the signal terminals 114.

The operation principle of the touch screen 1 will be described hereinafter. When the signal terminals 114 are charged, the entire resistive layer 112 has an electric field with the distribution of the equipotential lines L₁ as is shown in FIG. 3. If a user presses a position of the resistive layer 112, the electric field of the resistive layer 112 changes and the signal terminals 114 located at the corner surfaces will generate signals according to the current variations. Then, the generated signals are transmitted to the backend through the external circuit 12, so that the pressed position can be obtained after the further process of signals received by the backend.

However, as shown in FIG. 2, the conductive circuit layer 113 is in contact with the resistive layer 112 by only the bottom surface A₁. Thus, the current transmitted from the conductive circuit layer 113 to the resistive layer 112 is constricted, so that the potential of the electric field generated by the resistive layer 112 is decreased, thereby affecting the sensitivity of the touch screen 1. In addition, the end portions E₁ of the equipotential lines L₁ as shown in FIG. 3 are seriously crooked, which decreases the preciseness of the touch screen 1.

### SUMMARY OF THE INVENTION

In view of the foregoing, the invention is to provide a touch panel and touch screen that have high sensitivity and preciseness, simplified manufacturing processes, enhanced performance and decreased manufacturing cost.

To achieve the above, the invention discloses a touch panel including a substrate, a conductive circuit layer, a resistive layer and a dielectric layer. The substrate has a touch area and a peripheral area. The conductive circuit layer is formed on the peripheral area of the substrate. The resistive layer covers the conductive circuit layer and the touch area of the substrate. The dielectric layer is formed on the resistive layer. Herein, the conductive circuit layer includes a plurality of signal terminals disposed on corner surfaces of the substrate to serve as corner electrodes of the conductive circuit layer. The signal terminals are used to apply voltage to the touch panel and receive current.

In addition, the invention also discloses a touch screen including a touch panel and an external circuit. The touch panel includes a substrate, a conductive circuit layer, a resistive layer and a dielectric layer. The substrate has a touch area and a peripheral area. The conductive circuit layer is formed on the peripheral area of the substrate. The resistive layer covers the conductive circuit layer and the touch area of the substrate. The dielectric layer is formed on the resistive layer. The conductive circuit layer includes a plurality of signal terminals disposed on corner surfaces of the substrate to serve as corner electrodes of the conductive circuit layer. The signal terminals are electrically connected to the external circuit so as to apply voltage to the touch panel and receive current from touch panel.

As mentioned above, in the touch panel and touch screen of the present invention, the conductive circuit layer is formed on the substrate, and the resistive layer is formed on the conductive circuit layer. Thus, more surfaces of the conductive circuit layer can be in contact with the resistive layer so as to increase the transmitted current and enhance the sensitivity and preciseness. In addition, since the dielectric layer is formed on the resistive layer, the resistive layer and the dielectric layer can be performed in a single deposition apparatus. Therefore, the manufacturing processes can be simplified, the performance can be enhanced and the manufacturing cost can be decreased.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic illustration showing a conventional touch screen;

FIG. 2 is a sectional view showing a part of the conventional touch screen;

FIG. 3 is a schematic illustration showing the distribution of the equipotential lines in the electric field of the touch screen;

FIG. 4 is a schematic illustration showing a touch screen according to a preferred embodiment of the present invention;

FIG. 5 is a sectional view showing a part of the touch screen of FIG. 4;

FIG. 6 is a sectional view showing a part of another touch screen according to the embodiment of the present invention; and

FIG. 7 is a schematic illustration showing the distribution of the equipotential lines in the electric field of the touch screen of FIG. 4.

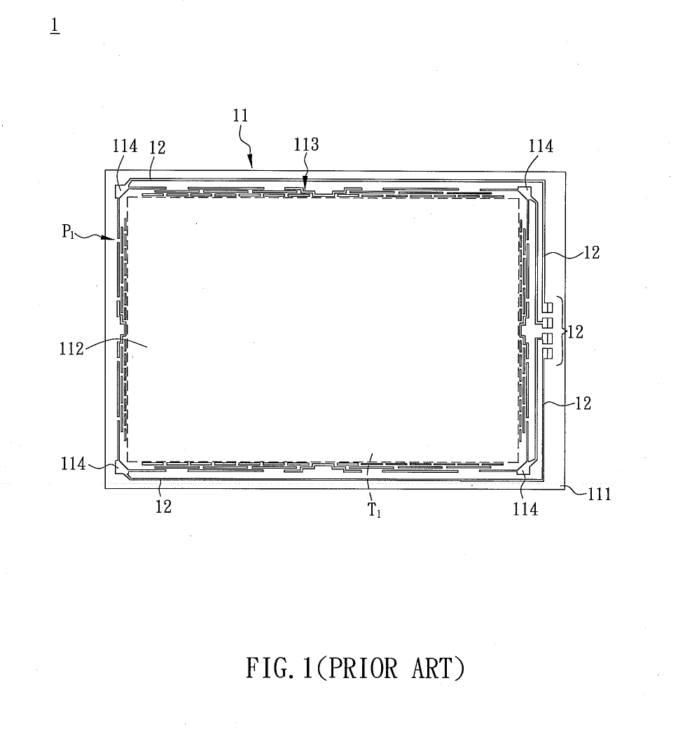

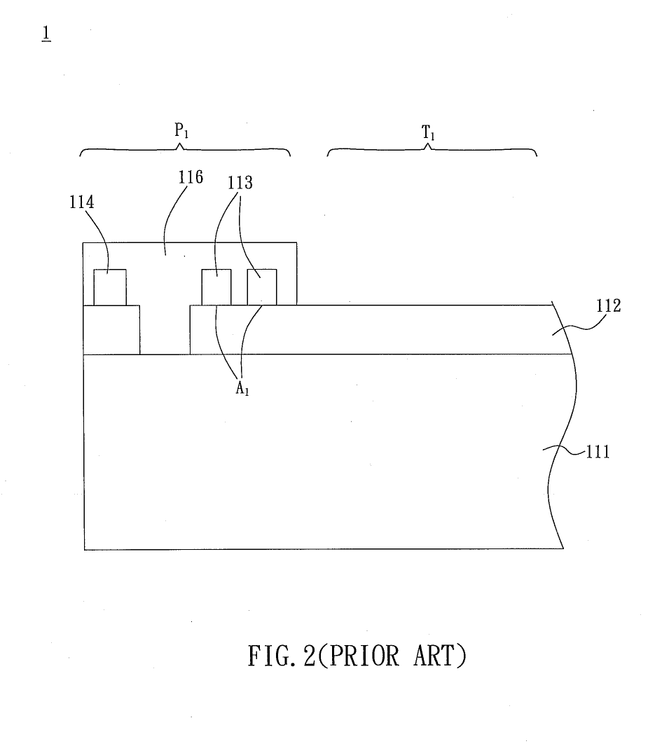

### DETAILED DESCRIPTION OF THE INVENTION

The present invention will be apparent from the following detailed description, which proceeds with reference to the accompanying drawings, wherein the same references relate to the same elements.

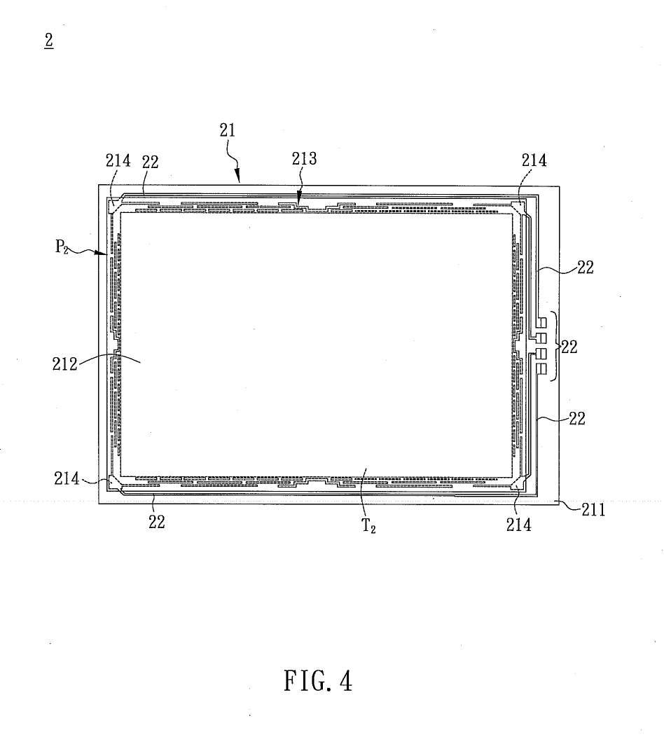

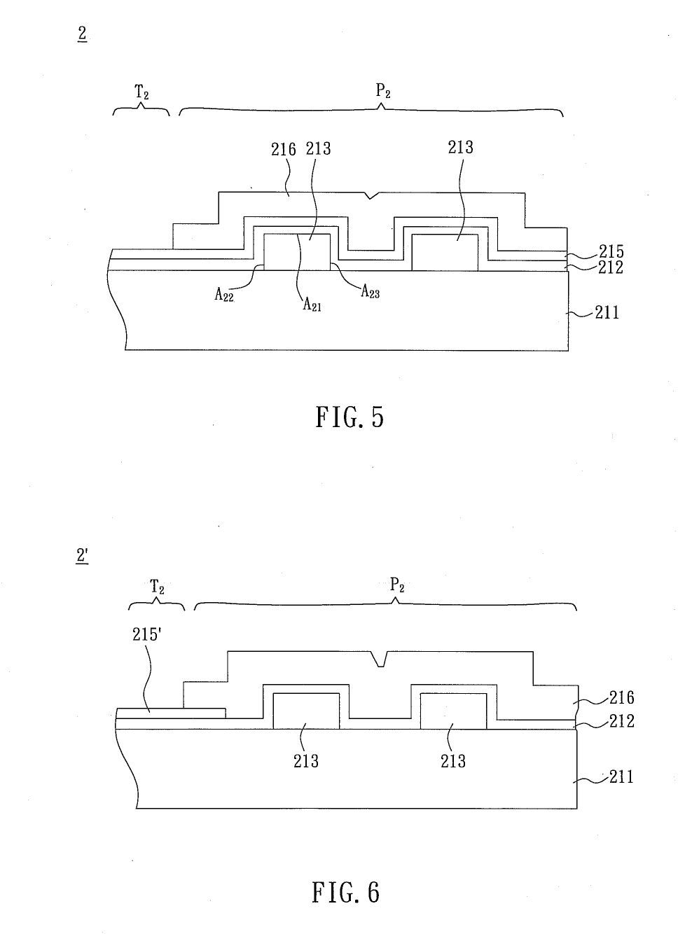

FIG. 4 shows a touch screen 2 according to a preferred embodiment of the present invention, and FIG. 5 is a sectional view showing a part of the touch screen 2. With reference to FIGS. 4 and 5, the touch screen 2 includes a touch panel 21 and an external circuit 22. The touch panel 21 includes a substrate 211, a conductive circuit layer 213, a resistive layer 212, a dielectric layer 215 and a protective layer 216.

The substrate 211 has a touch area T₂ and a peripheral area P₂ disposed around the touch area T₂. In the embodiment, the substrate 221 can be, for example but not limited to, a glass substrate or a plastic substrate. The conductive circuit layer 213 is formed on the peripheral area P₂ of the substrate 211 by coating, printing, adhering or deposition. The conductive circuit layer 213 can be discontinuous electrodes as the dot lines shown in FIG. 4. The material of the conductive circuit layer 213 is, for example, copper or silver glue.

The conductive circuit layer 213 includes a plurality of signal terminals 214 disposed on the corner surfaces of the substrate 211. In the embodiment, the signal terminals 214 can serve as the corner electrodes of the conductive circuit layer 213 for applying voltage to and receiving current from the touch panel 2. The signal terminals 214 and the conductive circuit layer 213 can be formed simultaneously. The external circuit 22 is electrically connected to the signal terminals 214.

The resistive layer 212 covers the conductive circuit layer 213 and the touch area T₂ of the substrate 21. The material of the resistive layer 212 can be transparent conductive metal oxide such as indium tin oxide (ITO), indium zinc oxide (IZO), aluminum-doped zinc oxide (AZO), tin oxide (SnO,SnO₂), gallium zinc oxide (GZO) or zinc oxide (ZnO).

The dielectric layer 215 is formed on the resistive layer 212. In the embodiment, the dielectric layer 215 includes at least a hardening layer and/or an anti-reflective layer. In practice, the hardening layer can be formed before or after the formation of the anti-reflective layer. The material of the anti-reflective layer can include, for example, silicon oxide (SiO), silicon nitride (SiN), silicon nitrogen oxide (SiON), niobium oxide, titanium oxide, aluminum oxide, aluminum nitride, tantalum oxide, zirconium oxide, magnesium oxide or cryolite (Na₃AlF₆). To be noted, the resistive layer 212 and the dielectric layer 215 can be formed by the same deposition apparatus, so that the manufacturing processes can be simplified.

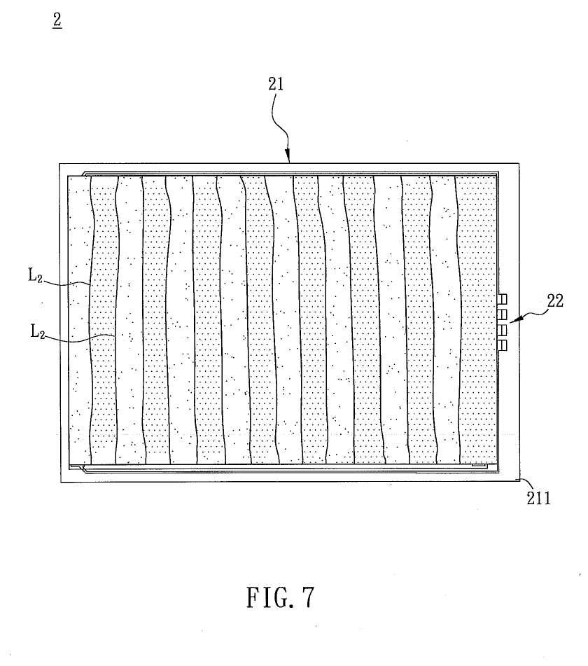

Alternatively, the dielectric layer can have another aspect as shown in FIG. 6. Referring to FIG. 6, a touch screen 2′ includes a dielectric layer 215′ disposed on a portion of the resistive layer 212 located on the touch area T₂.

The protective layer 216 is formed on a portion of the dielectric layer 215 located on the peripheral area P₂, as shown in FIG. 5, or a portion of the resistive layer 212 located on the peripheral area P₂, as shown in FIG. 6. The material of the protective layer 216 can be, for example, epoxy, acrylic glue or silicon. In the embodiment, the protective layer 216 can protect the conductive circuit layer 213 and the signal terminals 214.

When the signal terminals 214 are charged, the entire resistive layer 212 has an electric field with the distribution of the equipotential lines L₂ shown in FIG. 7. If a user presses a position of the touch area T₂, the electric field of the resistive layer 212 changes and the signal terminals 214 located at the corner surfaces will receive the varied signals. Then, the generated signals are transmitted to the backend through the external circuit 22, so that the pressed position can be obtained after the further process of signals received by the backend. The external circuit 22 includes, for example, the trace(s), flat cable(s) and chip(s).

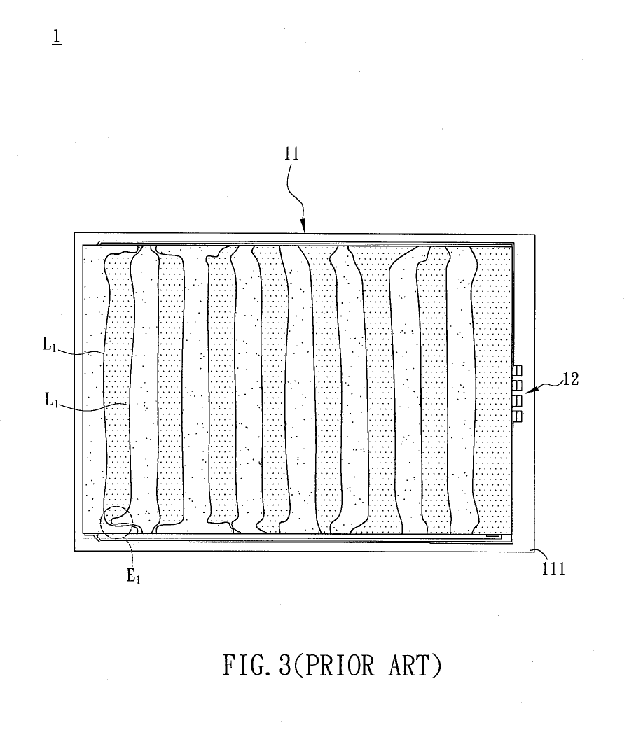

Referring to FIG. 5, the conductive circuit layer 213 is in contact with the resistive layer 212 by not only the bottom surface A₂₁ but also the side surfaces A₂₂ and A₂₃. Compared with the prior art, the present invention can increase the transmitted current as well as the potential of the electric field formed by the conductive circuit layer 213. In addition, the end portions of the equipotential lines L₂ as shown in FIG. 7 are not crooked (compared with the end portions E₁ as shown in FIG. 3), so that the preciseness of the touch screen 2 can be enhanced.

In summary, in the touch panel and touch screen of the present invention, the conductive circuit layer is formed on the substrate, and the resistive layer is formed on the conductive circuit layer. Thus, more surfaces of the conductive circuit layer can be in contact with the resistive layer so as to increase the transmitted current and enhance the sensitivity and preciseness. In addition, since the dielectric layer is formed on the resistive layer, the resistive layer and the dielectric layer can be performed in a single deposition apparatus. Therefore, the manufacturing processes can be simplified, the performance can be enhanced and the manufacturing cost can be decreased.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A touch panel comprising:
a substrate having a touch area and a peripheral area;
a conductive circuit layer formed on the peripheral area of the substrate;
a resistive layer formed on the conductive circuit layer and the touch area of the substrate; and
a dielectric layer formed on the resistive layer or a portion of the resistive layer located on the touch area.

2. The touch panel according to claim 1, wherein the conductive circuit layer comprises a plurality of signal terminals disposed on corner surfaces of the substrate to serve as corner electrodes of the conductive circuit layer.

3. The touch panel according to claim 1, wherein the substrate is a glass substrate or a plastic substrate.

4. The touch panel according to claim 1, wherein a material of the conductive circuit layer comprises copper or silver glue.

5. The touch panel according to claim 1, wherein the conductive circuit layer comprises discontinuous electrodes.

6. The touch panel according to claim 1, wherein a material of the resistive layer comprises a transparent conductive material.

7. The touch panel according to claim 6, wherein the transparent conductive material comprises indium tin oxide (ITO), indium zinc oxide (IZO), aluminum-doped zinc oxide (AZO), tin oxide (SnO,SnO₂), zinc gallium oxide or zinc oxide.

8. The touch panel according to claim 1, wherein the dielectric layer at least comprises an anti-reflective layer and/or a hardening layer.

9. The touch panel according to claim 8, wherein a material of the anti-reflective layer comprises silicon oxide, silicon nitride or silicon nitrogen oxide, niobium oxide, titanium oxide, aluminum oxide, aluminum nitride, tantalum oxide, zirconium oxide, magnesium oxide or Cryolite (Na₃AlF₆).

10. The touch panel according to claim 1, further comprising:
a protective layer formed on a portion of the dielectric layer on the peripheral area or a portion of the resistive layer on the peripheral area.

11. The touch panel according to claim 10, wherein a material of the protective layer comprises epoxy, acrylic glue or silicon.

12. A touch screen comprising:
a touch panel comprising:
a substrate having a touch area and a peripheral area,
a conductive circuit layer formed on the peripheral area of the substrate,
a resistive layer formed on the conductive circuit layer and the touch area of the substrate, and
a dielectric layer formed on the resistive layer or a portion of the resistive layer located on the touch area; and
an external circuit for applying voltage to the touch panel and receiving current from the touch panel.

13. The touch screen according to claim 12, wherein the dielectric layer at least comprises an anti-reflective layer and/or a hardening layer.

14. The touch screen according to claim 13, wherein a material of the anti-reflective layer comprises silicon oxide, silicon nitride or silicon nitrogen oxide, niobium oxide, titanium oxide, aluminum oxide, aluminum nitride, tantalum oxide, zirconium oxide, magnesium oxide or cryolite (Na₃AlF₆).

15. A manufacturing method of a touch screen comprising steps of:
providing a substrate having a touch area and a peripheral area;
forming a conductive circuit layer on the peripheral area of the substrate;
forming a resistive layer on the conductive circuit layer and the touch area of the substrate; and
forming a dielectric layer on the resistive layer or a portion of the resistive layer located on the touch area.

16. The method according to claim 15, wherein the conductive circuit layer comprises discontinuous electrodes and a plurality of signal terminals disposed on corner surfaces of the substrate to serve as corner electrodes of the conductive circuit layer.

17. The method according to claim 15, wherein the conductive circuit layer is formed on the substrate by coating, printing, adhering or deposition.

18. The method according to claim 15, wherein the dielectric layer at least comprises an anti-reflective layer and/or a hardening layer, and a material of the anti-reflective layer comprises silicon oxide, silicon nitride, silicon nitrogen oxide, niobium oxide, titanium oxide, aluminum oxide, aluminum nitride, tantalum oxide, zirconium oxide, magnesium oxide or cryolite (Na₃AlF₆).

19. The method according to claim 15, further comprising a step of:
forming a protective layer on a portion of the dielectric layer located on the peripheral area or a portion of the resistive layer located on the peripheral area, wherein a material of the protective layer comprises epoxy, acrylic glue or silicon.

20. The method according to claim 15, wherein the steps of forming the resistive layer and the dielectric layer are performed by one deposition apparatus.
